(19) United States
(12) Patent Application Publication
(10) Pub. No.: US 2006/0294141 A1
(43) Pub. Date: Dec. 28, 2006

(54) Smart business object proxy

(75) Inventors: Kwong Ping Tsang, Markham (CA); Ida Seen Yee Leung, Markham (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/169,095

(22) Filed: Jun. 28, 2005

(51) Int. Cl. G06F 17/00

(52) U.S. Cl. 707/104.1

(57) ABSTRACT

Embodiments of the invention provide a method, system and apparatus for a smart business object configured for disposal within the logic layer to insulate the logic and data persistence layers from changes in the presentation layer. In one embodiment, a smart business object framework can include a smart business object proxy disposed between a presentation layer and a logic layer in a multi-tier architecture. The framework further can include one or more resource brokers configured for communicative coupling to the smart business object proxy. Moreover, the resource brokers can be programmed to manage access to corresponding resources in the architecture.

### BACKGROUND OF THE INVENTION

1. Field of the Invention

The present invention relates to the field of three-tiered client-server computing and more particularly to the deployment of business objects in a multi-tier enterprise architecture.

2. Description of the Related Art

Traditional client server application mix presentation and business logic in the client tier while the server tier provides backend data storage and server side business logic. Consequently, client server applications typically cannot scale within the enterprise given the difficulty in maintaining both the client tier and the server tier. Specifically, changes to the presentation layer of an application require the modification of the client side application which can impact the integrity of the business logic within the client tier. Similarly, changes to the business logic of the client can jeopardize the integrity of the presentation code in the client tier. Accordingly, a three-tier approach often is preferred in which each of the presentation, logic and data persistence layers are separate from one another.

To force the separation of the presentation and logic layers as is preferred among contemporary computer scientists, server page technologies have become the preferred vehicle for multi-tier application. Server page technologies release the client tier from the responsibility of processing logic for rendering the presentation layer. Moreover, server pages largely separate presentation layer logic from the static elements of the presentation layer so that user interface designers can perform changes to the static elements of the presentation layer without breaching the integrity of the programmatic elements of the presentation layer.

FIG. 1 is a schematic illustration of a conventional three-tier architecture known in the art. The conventional three-tier architecture can include a presentation layer defined by a view 110, a logic layer defined by business logic 120 coupled to data processing logic 130, and a data persistence layer defined by persistent storage 150 coupled to data access logic 140. In operation, the view 110 can request data processing from business logic 120. To the extent that the requested data processing requires access to persistent storage 150, the data processing logic 130 can communicate with the data access logic 140 to retrieve the required data (or to write entries to the persistent storage 150.

It will be recognized by the generic three-tier architecture shown in FIG. 1 can be limited in scalability. Specifically, as those responsible for the presentation layer require extensions 160 to the view 110, for example the rendering of additional data not previously requested, modifications must occur in the logic layer to provide additional data processing logic 170 to process the requisite data for the extensions 160 to the view 110. The problem can be compounded where the data processing logic 170 requires access to elements of the persistent storage 150 not previously enabled. In that circumstance, additional data access logic 180 must be provided in the data persistence layer. Thus, minor changes to the requirements of the presentation layer can necessitate changes throughout the entire three-tier architecture.

### BRIEF SUMMARY OF THE INVENTION

Embodiments of the present invention address deficiencies of the art in respect to the conventional three-tier architecture and provide a novel and non-obvious method, system and apparatus for a smart business object configured for disposal within the logic layer to insulate the logic and data persistence layers from changes in the presentation layer. In this regard, in an embodiment of the present invention, a smart business object framework can include a smart business object proxy disposed between a presentation layer and a logic layer in a multi-tier architecture. The framework further can include one or more resource brokers configured for communicative coupling to the smart business object proxy. Moreover, the resource brokers can be programmed to manage access to corresponding resources in the architecture.

In another embodiment of the invention, a method for managing data requests from a view in a multi-tier architecture can include receiving a request from the view in a smart business object proxy and determining from the request a resource broker programmed to broker the request. The method further can include providing the request to the resource broker and receiving a result from the resource broker. Finally, the method can include forwarding the result to the view. In a first aspect of the invention, the determining step can include extracting markup language from the request and parsing the markup language to identify the resource broker. For instance, the parsing step further can include parsing the markup language to identify data to be retrieved through the resource broker. In this instance, the parsing step further can include parsing the markup language to identify a format for the data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a conventional three-tier architecture known in the art;

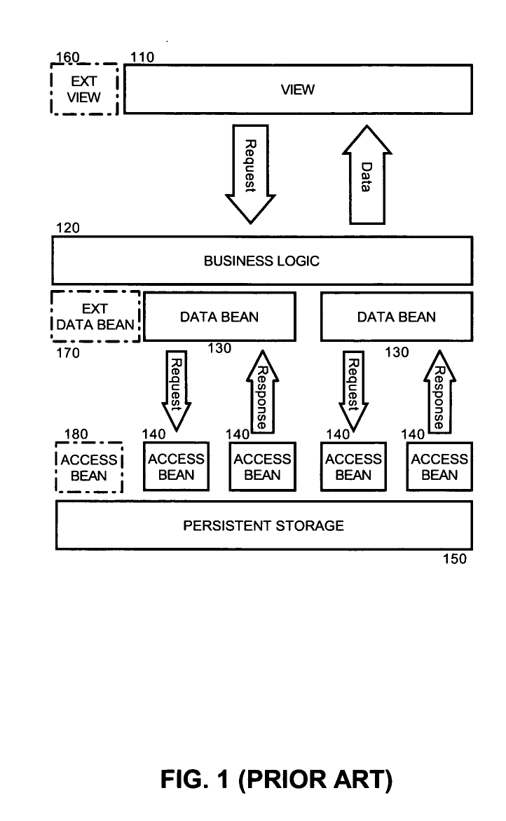

FIG. 2 is a schematic illustration of a multi-tier framework configured to support a smart business object in accordance with the inventive arrangements;

FIG. 3 is a block diagram illustrating a model for the smart business object of FIG. 2; and,

FIG. 4 is a flow chart illustrating a process for handling presentation layer requests for data in the smart business object of FIG. 2.

### DETAILED DESCRIPTION OF THE INVENTION

Embodiments of the present invention provide a smart business object and a multi-tier framework which has been configured to support the smart business object. In accordance with one embodiment of the present invention, a smart business object can act as a proxy between the view of the presentation layer and the business logic of the logic layer of the multi-tier framework. Additionally, the data access layer of the multi-tier framework can be partially promoted to the logic layer in the form of resource brokers programmed to locate and access requested resources (including persistent data) in a manner which is transparent to the business logic of the logic layer. In consequence, the smart business object can include programming to access requested data provided not only by the business logic of the logic layer, but also by the resources accessible through the resource brokers.

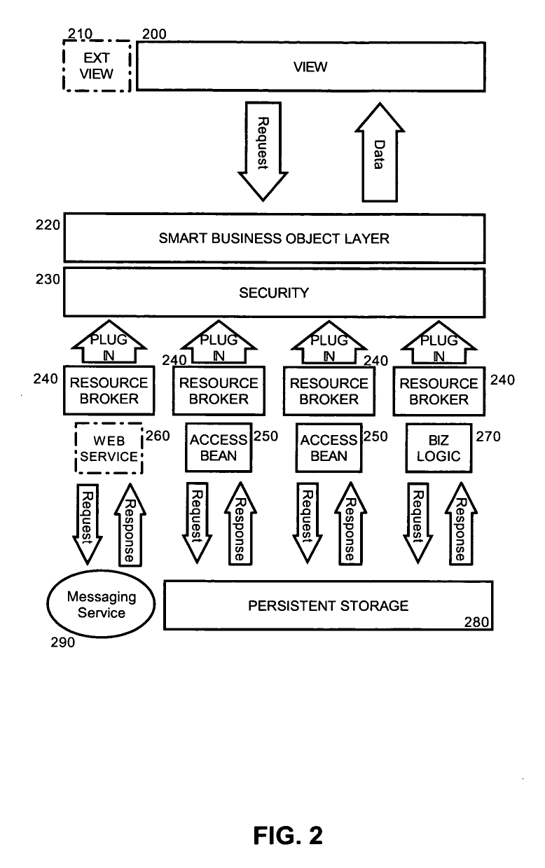

In more particular illustration, FIG. 2 is a schematic illustration of a client-server framework incorporating a smart business object in accordance with the inventive arrangements. The framework can include a view 200, a smart business object layer 220, a security layer 230 coupled to the smart business object layer, business logic 270 defining an application in the framework, and a plurality of resource brokers 240 configured as plug-ins to the smart business object layer 220. Additionally, persistent storage 280 can included within the framework which can satisfy data requests from access logic 250 coupled to the resource brokers 240. Notably, the business logic 270 can reside at the same level within the framework as the resource brokers 240.

In operation, the view 200 can transmit a request to the smart business object layer 220 which can include not only a request to access the data or functionality of a resource, but also the request can include a specification of the desired formatting for a result produced by the request. The smart business object layer 220 can receive the request and can parse the request to identify not only the nature of the request, but also the specification of the desired formatting for the result. The smart business object layer 220 in turn can identify a resource broker 240 able to satisfy the request and the smart business object layer 220 can invoke the identified resource broker 240.

The resource brokers 240 can include programming to access not only data from within the persistent storage 280, but also other resources, including one or more messaging services 290, or for instance Web service 260, and the processing resources of the business logic 270. In this regard, the framework of the present invention can delegate data access to the resource brokers 240. Accordingly, any service or data access implementation can be plugged into the resource broker, thus shielding presentation and the logic layers of the framework from changes to the data or schema. Moreover, reusability can be achieved at the resource broker level instead of merely extending and loading already complex data access logic to provide expanded functionality.

Thus, the identified resource broker 240 can service the request and provide the result to the smart business object layer 220. For instance, where the request requires the accessing of data in the persistent storage 280, the request broker 240 can access the data in the persistent storage 280 through a corresponding access bean 250. Alternatively, where the request requires the accessing of functionality provided by the business logic 270, the request broker 240 can invoke the business logic 270 accordingly. Finally, where the request requires the accessing of the functionality of one or more messaging services 290, the request broker 240 can invoke the functionality of the messaging services 290.

Once the smart business object layer 220 has received a response from the selected resource broker 240, the smart business object layer 220 can consult the original request from the view 200 to determine a suitable formatting for the result. Subsequently, the result can be formatted and returned to the view 200. Thus, the smart business object layer 220 manages data access instructions in the requests, and the smart business object layer 220 formats resulting data in a manner preferred by the view 200 as specified in a request. Therefore, the smart business object layer 220 can bind the transfer of data based on a defined structure, and the engine to access the data, without having to drive the actual implementation of the engine itself.

The requests forwarded by the view 200 can be encapsulated in a markup language document so as to facilitate the identification of the resources to be retrieved, the manner in which the resources can be retrieved, and the format in which the resulting resources are to be provided to the view 200. For example, the following markup can represent a request for data processing in a commerce system defined by the framework:

<Input parameter1 = value1>
<Input parameter2 = value2>
<Broker1 as class1 >

<class1.parameter1 = parameter1>
<class1 = method1(parameter1)>
<ExtBroker1 as extclass1>

<extclass1.member1 = class1.parameter2>

<Broker2 as class2>

<class2.parameter1 = parameter1>

<member1 = class2.method1( )>
<member2 = class2.method2( )>

As a continued example, the result for the request can be provided in a markup language document as follows:

<Input parameter1 = value1>
<Input parameter2 = value2>
<class1>

<resultfield1 = Rejected By Security >
<resultfield2 = result_data2>
<extclass1>

<resultfield1 = result_data1>

<class 2>

<resultfield1 = result_data1>
<resultfield2 = result_data2>

Hence, the markup of the present invention can be a representation of a business object accessible in the smart business object layer 220. The markup defines how the data is to be collected by building upon access points made available by the resource broker 240, and also the relationship of the data sets within the business object. The business objects, in turn, can be dynamically modeled according to the real-world business problem at hand.

Importantly, an extension 210 to the view 200 need not necessitate corresponding extensions to the business logic 270, the access logic 250 and the persistent storage 280. Rather, the extension 210 merely need specify the desired data and a preferred formatting for the data. The smart business object layer 220 in turn can locate a suitable resource broker 240 to provide the requested data. Thus, the framework of the present invention provides substantial advantages over the conventional three-tier hierarchy.

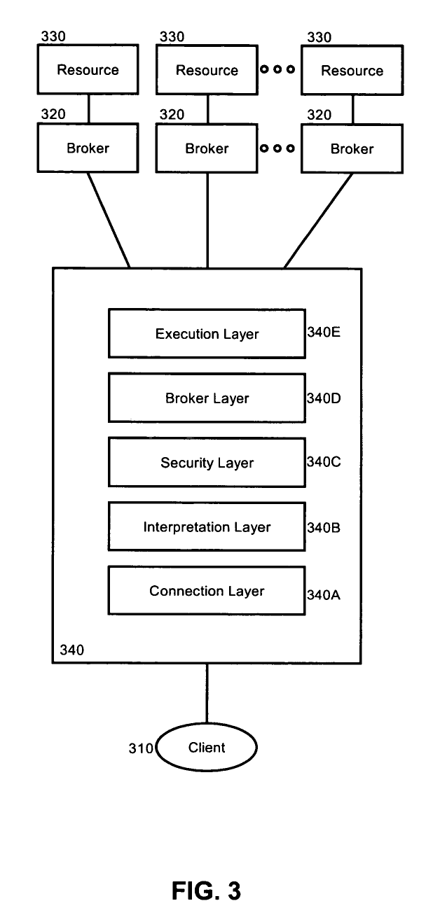

In further illustration, FIG. 3 is a block diagram illustrating a structure for the smart business object of FIG. 2. As shown in FIG. 3, a smart business object 340 can act as a proxy on behalf of a client 310 to the resources 330 to which access can be provided by corresponding resource brokers 320. The smart business object 340 can be a multi-layer object having a connection layer 340A for managing the request/response interactions with the client 310. An interpretation layer 340B can parse the markup of a request to identify the resource brokers 320 required to access the desired resources 330 on behalf of the client 310. Optionally, a security layer 340C can be provided which can ensure that requested resources and resulting data can be provided to the client 310 while meeting the security policies of the framework. A broker layer 340D can be provided to identify brokers 320 for servicing the requests and for formatting the requests for the brokers 320 appropriately. Finally, an execution layer 340E can be provided to execute requests for the brokers 320 to satisfy the resource requests of the client 310.

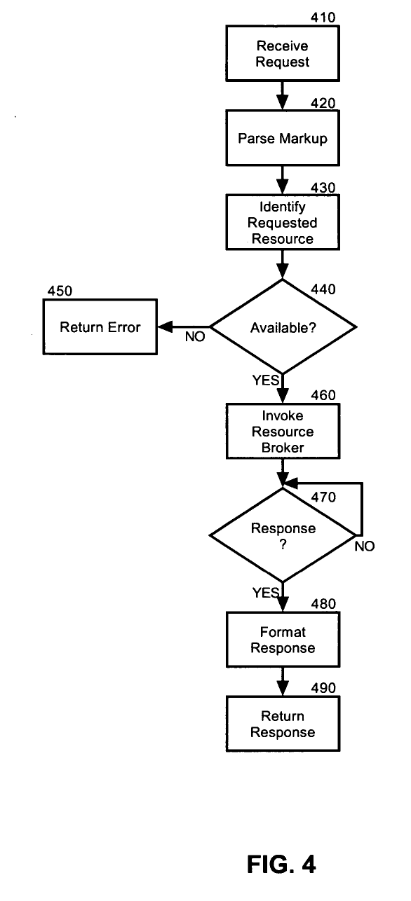

FIG. 4 is a flow chart illustrating a process for handling presentation layer requests for data in the smart business object of FIG. 2. Beginning in block 410, a request can be received for resources from a view client. The resources can include, but are not limited to data resources, business logic, or messaging services, to name only a few resources. In block 420, the markup of the request can be parsed and in block 430 the requested resources and corresponding brokers able to service the request can be identified. In decision block 440, it can be determined whether the specified broker is available to service the request. If not, an error condition can occur in block 450. Otherwise, the process can continue through block 460.

In block 460, the specified resource broker can be invoked to provide access to the requested resource. In decision block 470, it can be determined whether the resource broker has provided responsive data which can range from an affirmation that the requested resource has performed the requested action, to values indicative of a result of processing. If so, in block 480 the responsive data can be formatted as specified by the markup in the request. Finally, in block 490, the response can be returned to the requesting client view.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A smart business object framework, for managing data requests, comprising:
a smart business object proxy disposed between a presentation layer and a logic layer in a multi-tier architecture; and,
a plurality of resource brokers configured for communicative coupling to said smart business object proxy and programmed to manage access to corresponding resources in said architecture.

2. The smart business object framework of claim 1, wherein said corresponding resources comprise data access logic.

3. The smart business object framework of claim 1, wherein said corresponding resources comprise messaging services.

4. The smart business object framework of claim 1, wherein said presentation layer comprises a view.

5. The smart business object framework of claim 1, wherein said logic layer comprises both said resource brokers and business logic.

6. The smart business object framework of claim 1, wherein said smart business object proxy comprises:
a communication layer;
an interpretation layer;
a broker layer; and,
an execution layer.

7. The smart business object framework of claim 6, wherein said smart business object proxy further comprises a security layer.

8. A method for managing data requests from a view within an implementation of a multi-tier architecture, the method comprising:
receiving a request from the view in a smart business object proxy;
determining from said request a resource broker programmed to broker said request;
providing said request to said resource broker;
receiving a result from said resource broker; and,
forwarding said result to the view.

9. The method for managing data requests of claim 8, wherein said determining step further comprises:
extracting markup language from said request; and,
parsing said markup language to identify said resource broker.

10. The method for managing data requests of claim 8, wherein said parsing step further comprises:
parsing said markup language to identify data to be retrieved through said resource broker.

11. The method for managing data requests of claim 10, wherein said parsing step further comprises:
parsing said markup language to identify a format for said data.

12. The method for managing data requests of claim 8, wherein said providing step further comprises:
providing said request to said resource broker for routing to a resource selected from a group comprising: business logic, data access logic and a messaging service.

13. A machine usable medium embodying a computer program for managing data requests from a view in a multi-tier architecture, the computer program comprising a routine set of instructions which when executed by a machine causes the machine to perform operations comprising:
receiving a request from the view in a smart business object proxy;
determining from said request a resource broker programmed to broker said request;
providing said request to said resource broker;
receiving a result from said resource broker; and,
forwarding said result to the view.

14. The machine usable medium of claim 13, wherein said determining step further comprises:
extracting markup language from said request; and,
parsing said markup language to identify said resource broker.

15. The machine usable medium of claim 13, wherein said parsing step further comprises:
parsing said markup language to identify data to be retrieved through said resource broker.

16. The machine usable medium of claim 15, wherein said parsing step further comprises:
parsing said markup language to identify a format for said data.

17. The machine usable medium of claim 13, wherein said providing step further comprises:
providing said request to said resource broker for routing to a resource selected from a group comprising: business logic, data access logic and a messaging service.
